(19) United States
(12) Patent Application Publication
(10) Pub. No.: US 2008/0002430 A1
(43) Pub. Date: Jan. 3, 2008

(54) DISPLAY WITH SELECTABLE VIEWING ANGLE

(75) Inventors: Udayan Kanade, Pune (IN); Balaji Ganapathy, Atlanta, GA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: I2iC Corporation

(21) Appl. No.: 11/754,253

(22) Filed: May 25, 2007

(30) Foreign Application Priority Data
May 25, 2006 (IN) 796/MUM/2006

(51) Int. Cl. F21V 7/04

(52) U.S. Cl. 362/613; 362/458

(57) ABSTRACT

A display with selectable viewing angles and methods pertaining thereto are disclosed. According to one embodiment, an apparatus comprises a display having at least two backlights. At least one of the backlights is primarily transparent and the at least two backlights emit light in different patterns of emanation.

The present application claims the benefit of and priority to Indian Provisional Patent Application No. 796/MUM/2006 entitled “Display with Selectable Viewing Angle” filed on May 25, 2006.

### FIELD

The present invention relates to electronics displays. More particularly the invention relates to an electronic display with a selectable viewing angle.

### BACKGROUND

Usually a personal computing device such as a laptop or a personal computer is used by a single user. But the light emanating from the display of such devices is spread in all directions. The ratio of the amount of light reaching the user viewing the display to the total amount of light emanated is quite small. Thus, a large amount of light energy is wasted. There are displays that emanate light in a narrow angle. However, on occasion, displays are required to be viewed by a number of people, as might occur during a presentation being made using a display.

Since light emanates from displays in all directions, the information displayed by these devices can be viewed by many people at a time. Thus, it is not possible for a display viewer to have viewing privacy. It is desirable to have privacy when operations such as reading private email or retrieving financial information are in progress. LCD panels on top of display devices reduce the angle of emanation in select regions of the screen. However, this leads to a reduced energy efficiency.

### SUMMARY

A display with selectable viewing angle is disclosed. According to one embodiment, an apparatus comprises a display having at least two backlights. At least one of the backlights is primarily transparent and the at least two backlights emit light in different patterns of emanation.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary backlight with selectable viewing angle, according to one embodiment.

FIG. 2 illustrates a block diagram of an exemplary backlight with selectable viewing angle having a reflecting surface, according to one embodiment.

FIG. 3 illustrates a block diagram of an exemplary backlight with selectable viewing angle having multiple transparent backlights, according to one embodiment.

FIG. 4 illustrates a block diagram of an exemplary backlight with selectable viewing angle having a transparent backlight, according to one embodiment.

FIG. 5 illustrates a flow diagram of an exemplary switching policy that checks the amount of battery power left, according to one embodiment.

FIG. 6 illustrates a flow diagram of an exemplary switching policy that checks the angular spread of viewers, according to one embodiment.

FIG. 7 illustrates a flow diagram of an exemplary switching policy that checks the current state of video output, according to one embodiment.

FIG. 8 illustrates a flow diagram of an exemplary switching policy that uses hints from applications, according to one embodiment.

FIG. 9A illustrates a schematic diagram, shown in disassembled form, of an illuminated light guide in the form of a sheet, according to one embodiment.

FIG. 9B illustrates a side view of an illuminated light guide, according to one embodiment.

FIG. 10 illustrates a block diagram of an exemplary light source, according to one embodiment.

FIG. 11 illustrates a block diagram of an exemplary light source, according to one embodiment.

FIG. 12 illustrates a block diagram of an exemplary light source, according to one embodiment.

FIG. 13 illustrates a flow diagram of an exemplary process for orienting aspherical particles in a light guide, according to one embodiment.

FIG. 14A illustrates an exemplary aspherical particle that has a preferred direction in which it can be easily magnetized, according to one embodiment.

FIG. 14B illustrates a block diagram of an exemplary aspherical particle placed under a magnetic field, according to one embodiment.

FIG. 14C illustrates a block diagram of an exemplary solidified light guide sheet with aspherical particles, according to one embodiment.

FIG. 14D illustrates a block diagram of an exemplary solidified light guide under a magnetic field, according to one embodiment.

FIG. 14E illustrates a block diagram of an exemplary solidified light guide under a variable magnetic field, according to another embodiment.

FIG. 15 illustrates a block diagram of an element of a core of a light source in the form of a surface, according to one embodiment.

FIG. 16 illustrates a block diagram of an exemplary light source in the form of a surface having a varied concentration of diffuser particles, according to one embodiment.

FIG. 17 illustrates an exemplary light source in the form of a surface having two light sources, according to one embodiment.

FIG. 18 illustrates a diagram of an exemplary light source in the form of a surface having a mirrored core, according to one embodiment.

FIG. 19 illustrates a flow diagram of an exemplary process for creating a concentration profile of particles in a light guide, according to one embodiment.

### DETAILED DESCRIPTION

A display with selectable viewing angle is disclosed. According to one embodiment, an apparatus comprises a display having at least two backlights. At least one of the backlights is primarily transparent and the at least two backlights emit light in different patterns of emanation.

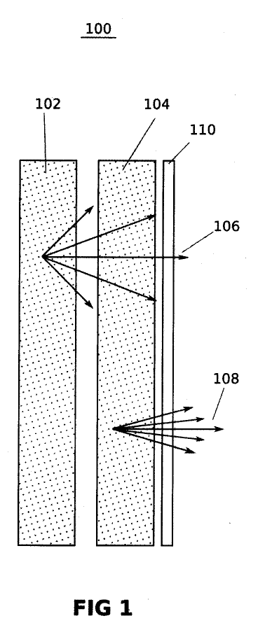

FIG. 1 illustrates a block diagram of an exemplary backlight with selectable viewing angle 100, according to one embodiment. Transparent backlight 102 emits light in a wide angle. Transparent backlight 104 emits light in a narrow angle. In an embodiment, transmissive display 110 is an LCD. In another embodiment, transmissive display has micro-optical switches. When backlight 104 is on, it emits light 108 in a narrow cone and display 100 has a narrow viewing angle. When backlight 102 is on, it emits light 106 in a wide cone. Light 106 travels through backlight 104. Backlight 104 is transparent to light 106 and the display 100 has a wide viewing angle.

In an alternate embodiment both backlight 102 and backlight 104 are emitting light simultaneously. This provides a display with a wide viewing angle with a better luminescence in a narrow viewing angle. In an alternate embodiment backlight 102 and backlight 104 are illuminated at required intensities to obtain different luminescence at different viewing angles.

In an embodiment, the transparent backlights 102 and 104 emit light primarily in the direction of the transmissive display 110.

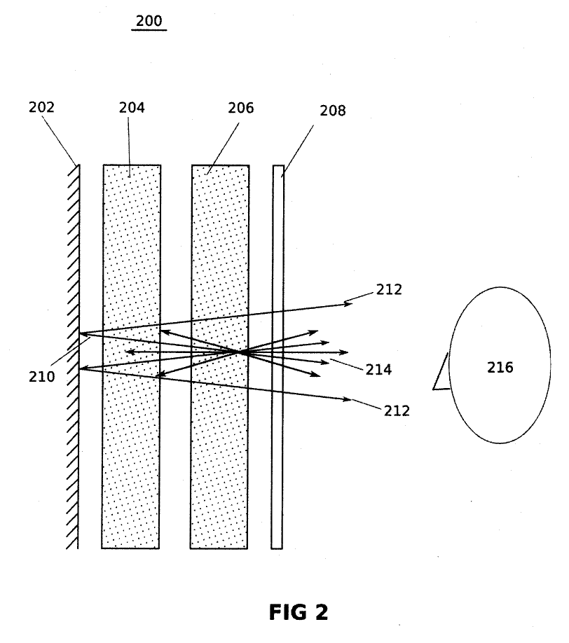

FIG. 2 illustrates a block diagram of an exemplary backlight with a selectable viewing angle 200 having a reflecting surface, according to one embodiment. Transparent backlight 204 emits light in a wide angle. Transparent backlight 206 emits light in a narrow angle. Light 214 is emitted from backlight 206 in a narrow cone in the direction of the viewer 216. Light 214 is modulated by display 208 and is seen by viewer 216. Light 210 is emitted from backlight 206 in a narrow cone in a direction opposite to the direction of light 214 and in the direction of the reflecting surface 202. Light 210 passes through backlight 204 and is incident on reflecting surface 202. Light 212 is light 210 reflected from reflecting surface 202. Light 212 has a narrow cone after reflection. Light 212 passes through backlight 204 and 206, and is modulated by display 208 and is seen by viewer 216. Light 210 which would be wasted in the absence of reflecting surface 202 reaches viewer 216 in a narrow cone in the presence of reflecting surface 202. Reflecting surface 202 is used to improve the efficiency of backlight 200 by utilising light 210. The reflecting surface 202 may be a metallic surface, bragg reflector, TIR reflector, omnidirectional reflector, hybrid reflector or any suitable technology for reflecting incident light.

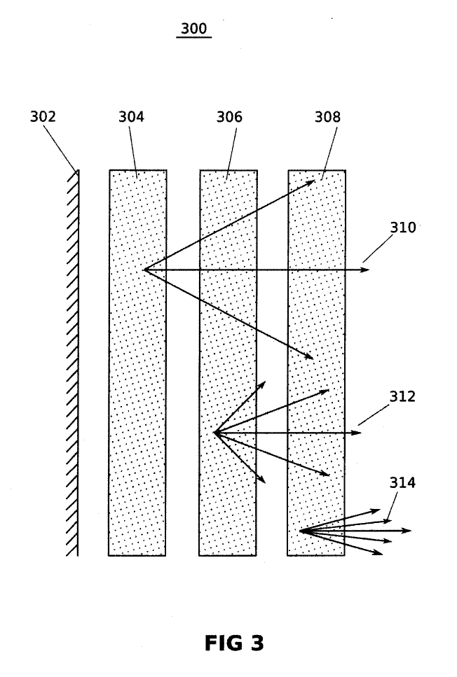

FIG. 3 illustrates a block diagram of an exemplary backlight with a selectable viewing angle 300 having multiple transparent backlights, according to one embodiment. Transparent backlights 304, 306 and 308 emit light 310, 312 and 314 respectively, in cones of different angles. They are illuminated at required intensities to obtain different luminescence at different viewing angles. Reflecting surface 302 is used to improve the efficiency of the backlight.

In various embodiments, any number of transparent backlights are used to obtain a required luminescence at different viewing angles in different states of illumination.

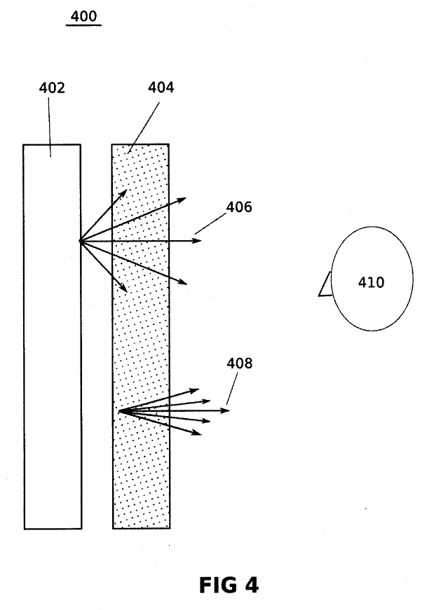

FIG. 4 illustrates a block diagram of an exemplary backlight with selectable viewing angle 400 having a transparent backlight, according to one embodiment. A backlight 402 is placed parallel to transparent backlight 404. A backlight 402 is placed farthest from viewer 410 if it is a non-transparent source of light. Backlight 402 and transparent backlight 404 emit light 406 and 408 in cones of different angles. In one embodiment, backlight 402 emits light in a wide cone and transparent backlight 404 emits light in a narrow cone. In an alternate embodiment, backlight 402 emits light in a narrow cone and transparent backlight 404 emits light in a wide cone. For example, backlight 402 may be a prior art narrow angle backlight such as a backlight comprising a prism sheet. In alternate embodiments, any number of transparent backlights are used.

FIG. 5 illustrates a flow diagram of an exemplary switching policy 500 that checks the amount of battery power left, according to one embodiment. The amount of battery power left is checked (510). If the battery power available is above a particular threshold, the display switches to a wide viewing angle (520). If the battery power available is below a threshold the display switches to a narrow viewing angle (530).

The policy 500 may be implemented in the operating system, the firmware or software of the device. In an alternate embodiment of the invention, the viewing angle is adjusted through an iterative process depending on the battery power available.

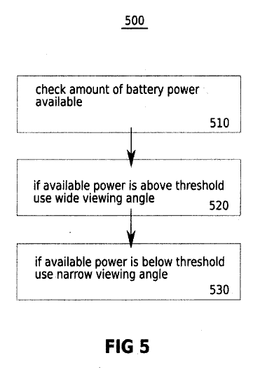

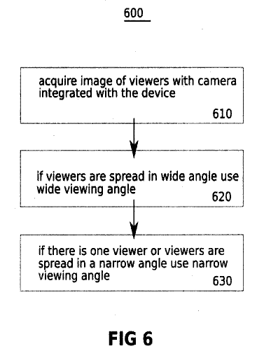

FIG. 6 illustrates a flow diagram of an exemplary switching policy 600 that checks the angular spread of viewers, according to one embodiment. An image of the viewers is captured using a camera (610). This image is processed to find the number of viewers and their angular spread. If the angular spread of viewers is large, the display switches to a wide viewing angle (620). If the angular spread of users is narrow or there is only one user then the display switches to a narrow viewing angle (630).

The policy 600 may be implemented in the operating system, the firmware or software of the device. In an alternate embodiment the viewing angle and direction of maximum emanation is adjusted according to the spread and location of viewers. In an alternate embodiment of the invention, the viewing angle is adjusted through an iterative process depending on the spread of viewers.

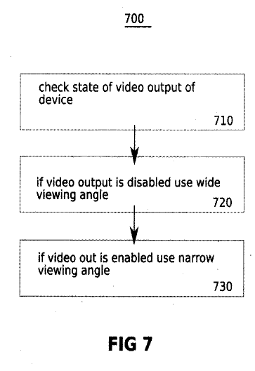

FIG. 7 illustrates a flow diagram of an exemplary switching policy 700 that checks the current state of video output, according to one embodiment. The state of video out is checked (710). If the video out is active, the display switches to a narrow viewing angle (720). If video out is not active the display switches to a wide viewing angle (730). The policy 700 may be implemented in the operating system, the firmware or software of the device.

FIG. 8 illustrates a flow diagram of an exemplary switching policy 800 that uses hints from applications according to one embodiment. When showing a presentation, movie or data which can have multiple simultaneous viewers, the application makes a request to the operating system to switch to a wide viewing angle (800). The operating system causes the display to switch to a wide viewing angle. When it has finished showing the data it makes a request to the operating system to switch the display back to a narrow viewing angle (820). The operating system causes display to switch to a narrow viewing angle. If the application does not make such a request, the operating system switches the display to narrow viewing angle after the process making the request to switch to narrow viewing angle terminates (830). Alternatively, a preset timeout is used to switch the display back to a narrow viewing angle.

According to one embodiment, multiple policies, such as 500, 600, 700 and 800, are used simultaneously.

In an alternate embodiment, a manual override is provided over the switching policies. The override is provided in hardware or software or firmware or in a combination of any two or more of the above. In an embodiment, the hardware override is a switch.

### Transparent Backlight

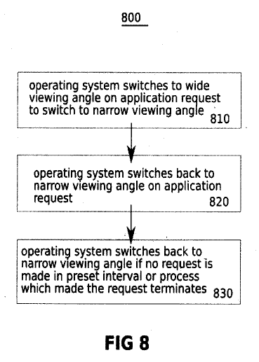

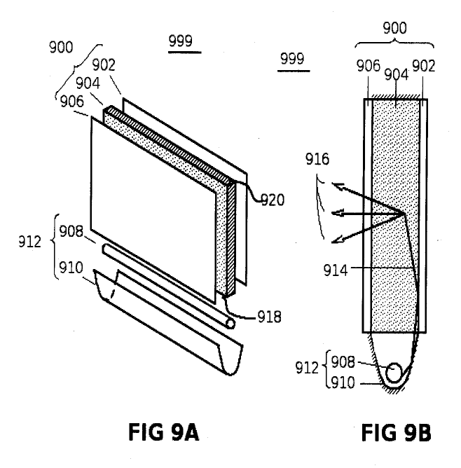

FIG. 9A illustrates a schematic diagram, shown in disassembled form, of an illuminated light guide in the form of a sheet 999, according to one embodiment. Light source 999 is primarily transparent and may have a light guide 906 with a core 904 surrounded by low index cladding sheets 903 and 905. The core 904 includes a diffuser, which is a sparse distribution of light dispersing particles. The diffuser in the core 904 is made up of metallic, organic, or other powder, or pigment, which reflects light incident on it. Alternatively, the diffuser in the core 104 may be constituted of small transparent particles or bubbles, which disperse light by refraction, reflection at the boundary, by diffusion inside the particle, or by total internal reflection. Linear light source 902 illuminates the light guide 906 from bottom edge 907. Top edge 908 does not have a reflective surface. Reflector 901 concentrates light from the linear light source 902 into the light guide 906. The light from a primary light source 902 is dispersed over the entire surface of the light guide 906 and exits from its large faces. The light guide 906 is thus primarily transparent and clear when viewed from one of its faces.

FIG. 9B illustrates a side view of an illuminated light guide 999, shown in assembled form, according to one embodiment. A light guide 900 is made up out of three sheets joined at their larger faces, each one transparent to light, the central sheet 904 (henceforth referred to as the core) being of higher refractive index than the two side sheets 902 and 906 (henceforth referred to as the cladding). The core 904 preferably has three of its edges made so as to reflect light. Adjacent to the non-reflective edge is an edge illuminator 912. Edge illuminator 912 consists of a primary light source 908 and a reflector 910. The primary light source 908 is a linear source of light. The primary light source 908 could be a fluorescent or gas discharge tube, or a bank of LEDs, or an incandescent filament, or any other similar light source. The reflector 910 is disposed so as to direct a maximum amount of light from the primary light source 908 into the core 904 such that it travels inside the core 904 at an angle parallel or almost parallel to the cladding sheets 902 and 906. A ray of light 914 is an exemplary light ray emanating from the edge illuminator 912 and travelling through the bulk of core 904. Since the ray 914 is at a glancing angle with respect to the claddings 902 and 906, it is kept inside the core 904 by total internal reflection. The three reflecting edges of the core 904 also keep the ray of light inside the core 904. A fine dispersion of light deflecting particles is provided throughout the core 904, at a very small concentration. After travelling a certain distance, the ray of light 914 comes close to a light deflecting particle. This light deflecting particle changes the angle at which the light 914 is travelling through the core 904, such that at least some of the light 914 is now travelling at an angle such that it will not get totally internally reflected at the cladding sheets 906 and 902. This light with a changed angle of travel emanates out of the light guide 900 as emanating light 916.

The systems and methods disclosed are applicable to various embodiments of the light conducting medium. For example, the light conducting medium may be a cylindrical or rectangular light guide instead of a light guide in the form of a sheet 900. Such light guides, oriented along a single linear axis, are usually termed as optical fibers. The light conducting medium may also have a bulk of transparent material through which light is traveling. Light may be contained within the light conducting medium by total internal reflection, as described with reference to FIG. 9B, or complete reflection, or any other optical principle. It is also possible that there are light containment structures. In this case, some light may be lost due to non-containment. Such loss may be minimized by focusing the light emanating from a light source (such as edge illuminator 912) such that a large quantity of light travels through the light conducting medium. Focusing the light may be achieved by reflectors or lenses. Systems providing highly directional light output such as lasers and directional light emitting diodes may also be used. More than one light source may be used.

In the light conducting medium, such as core 904, a fine dispersion of light deflecting particles is provided. The concentration of light deflecting particles may be the same at all locations of the light conducting medium, or may be different at different locations of the light conducting medium, the latter enabling uniform or preferred extraction of light from the light conducting medium.

The light deflecting particles, of which a fine dispersion is provided throughout the light conducting medium 904, deflect light using optical reflection, optical refraction, optical diffraction, optical dispersion or a combination of these.

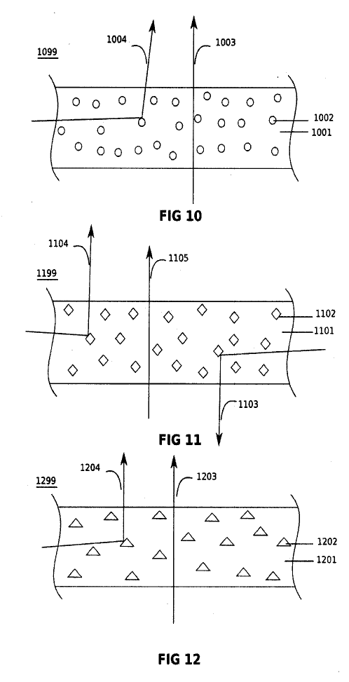

FIG. 10 illustrates a block diagram of an exemplary light source 1099, according to one embodiment. Light guide 1001 contains a dispersion of light deflecting particles, such as particle 1002. Light guide 1001 is illuminated from one or more of its edges. Light from the light guide 1004 is deflected by light deflecting particles 1002. Light incident on the face of the light guide 1001 passes through it unaffected. Thus the light source 1099 acts as a light source in the form of a sheet that is primarily transparent when viewed from its face.

Some embodiments have transparent backlights that emanate light in a preferred light emanation pattern, such as in a narrow cone. Some light sources provide light in the form of a sheet that act as backlights emitting light in a predetermined emanation pattern. Other light sources which emit light in a preferred emanation pattern may be substituted.

In an embodiment, light is extracted from the light conducting medium in a predetermined emanation pattern by light deflecting particles that are aspherical in shape. These aspherical particles are oriented such that the particle orientation is a function of position in the light conducting medium.

FIG. 11 illustrates a block diagram of an exemplary light source 1199, according to one embodiment. Light guide 1101 contains a dispersion of aspherical light deflecting particles, such as particle 1102. Light guide 1101 is illuminated from one or more of its edges. Aspherical particle 1102 is designed such that it disperses light incident on it in a preferred emanation pattern. In an embodiment, the emanation pattern pertaining to individual particles, such as particle 1102, is adjusted such that light extracted by a plurality of oriented aspherical particles emanates in a narrow cone. For example, particles with a square cross section, such as those depicted in FIG. 11, reflect light traveling in the light guide such that it emanates in a narrow cone. Light 1104 depicts an exemplary light ray deflected by the particle 1102. Light 1105 that is incident on the faces of the light guide 1101, passes through light guide 1101 unaffected. Thus light guide 1101 is a primarily transparent light source with a narrow angle of light emanation pattern.

FIG. 12 illustrates a block diagram of an exemplary light source 1299, according to one embodiment. Light guide 1201 contains a dispersion of aspherical light deflecting particles, such as particle 1202. Light guide 1201 is illuminated from one or more of its edges. The light emanation pattern pertaining to aspherical particle 1202 is designed to disperse light in only one direction. In an embodiment, particles with a triangular cross section, such as those depicted in the FIG. 12, reflect light traveling in the light guide such that it emanates in a single direction. Thus, a plurality of aspherical particles, such as particle 1202, dispersed in the light guide 1201 cause incident light to emanate from only of the two faces of the light guide 1201. Light 1203 incident on the face of the light guide 1201, passes through it unaffected. Thus light guide 1201 is a primarily transparent light source with light emanating from only one of its two faces.

### Particle Orientation

The light emanation pattern pertaining to a particle depends on its shape and orientation among many other parameters. For obtaining a particular light emanation pattern, aspherical particles may be designed that when collectively oriented in a particular manner impart a required light emanation pattern to the light guide.

For achieving a light guide emitting light in a certain light emanation pattern, it may be required that particles in it be oriented such that particle orientation is a function of its position in the light guide. The function that relates a particle's position in the light guide to its orientation is henceforth referred to as an orientation distribution profile of the particles with respect to the light guide.

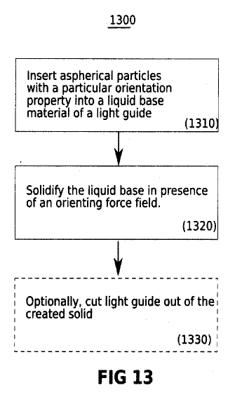

FIG. 13 illustrates a flow diagram of an exemplary process 1300 for orienting aspherical particles in a light guide, according to one embodiment. Aspherical particles with a particular orientation property are inserted into a liquid base material of a light guide (1310). An orientation property of an aspherical particle is a property by which particle orientation happens when subjected to an orienting force field. The liquid base material is solidified in the presence of an orienting force field (1320). In an embodiment, the solid produced thus is the final product. In an alternate embodiment, a section of the produced solid may be cut out to obtain the final light guide with particles oriented in a required direction (1330).

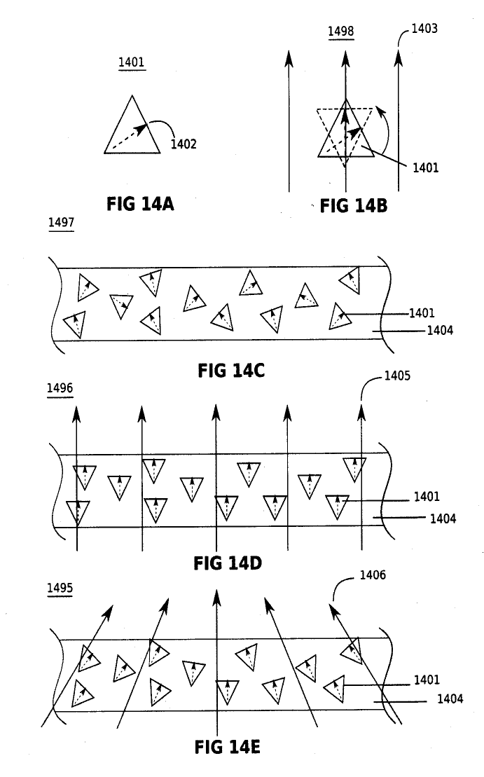

FIG. 14A illustrates an exemplary aspherical particle 1401 that has a preferred direction 1402 in which it can be easily magnetized, according to one embodiment. An aspherical particle orients itself in a magnetic field to align the direction of high magnetizability 1402 to the direction of the magnetic field. The possession of a direction of high magnetizability is thus a magnetic orientation property.

Many crystals posses a direction of high magnetizability, and such crystals may be used in the present embodiment. A crystal grown, sintered or annealed in the presence of a magnetic field grows to orient its direction of high magnetizability to the direction of the applied magnetic field. This property is used to produce crystalline or polycrystalline material having a net direction of high magnetizability. One such group of polycrystalline materials is that of composites such as magnetizable ceramics.

A composite material particle is a solid consisting of two or more different materials that are bonded together. Bonding may be done by mechanical or metallurgical processes such as sintering. One component in the composite may be a ferromagnetic material such as iron, cobalt, nickel or gadolinium which are subjected to a magnetic field while the composite is being compacted. The domains of such ferromagnetic material orient their direction of high magnetizability to the direction of the applied magnetic field while the composite is being formed. The collective orientation of component domains results in a composite material particle having a direction of high magnetizability.

[Copy 10B 4003] FIG. 14B illustrates a block diagram of an exemplary aspherical particle 1401 placed under the influence of a magnetic field 1403, according to one embodiment. Aspherical particle 1401 has an orientation property that it has a preferred direction of high magnetizability 1402. Under the influence of the magnetic field 1403, the particle 1401 gets magnetized along its preferred direction of high magnetizability 1402. Magnetized particle 1401 experiences a force to align its direction of magnetization with the direction of the applied magnetic field 1403. Thus the particle rotates around itself and gets oriented along the direction of the applied magnetic field 1403. Particle 1401 therefore has an orientation property that it has a preferred direction of high magnetizability which orients the particle in an orienting magnetic field.

FIG. 14C shows a block diagram of an exemplary light guide 1497 with aspherical particles, according to one embodiment. Several aspherical particles, such as particle 1401, having a preferred direction of high magnetizability, such as direction 1402 pertaining to particle 1401, are inserted into a base material 1404 of a light guide sheet.

FIG. 14D illustrates a block diagram of an exemplary solidified light guide 1496 under a magnetic field, according to one embodiment. The base material 1404 is solidified under the influence of a magnetic field 1405. In an embodiment, field lines of magnetic field 1405 are parallel. Magnetic field 1405 causes forces to act on aspherical particles, such as particle 1401, as discussed in conjunction with FIG. 14B. These forces orient the asphercial particles in a required direction.

FIG. 14E illustrates a block diagram of an exemplary solidified light guide 1495 under a variable magnetic field, according to another embodiment. The base material 1404 is solidified under the influence of a magnetic field 1406. Magnetic field 1406 is varied in intensity and direction throughout the base material 1404. Such a magnetic field orients the aspherical particles according to a particular orientation distribution profile. By controlling the magnetic field intensity and direction throughout the light guide, the orientation distribution profile of the aspherical particles can be controlled.

In other embodiments, the orientation field may be an electric field or a gravitational field.

### Particle Concentration

FIG. 9A illustrates a light guide in the form of a sheet with light diffusing particles in it, according to one embodiment. The light guide sheet diffuses light from a light source such that the diffused light has a preferred light emanation pattern.

The light emanation pattern may be same at different parts of the light guide sheet, or it may be different in different parts of the light guide sheet. The emanation pattern of light emanating out of a particular part of the light guide sheet depends not only on the shape and orientation of the particles, but also on the concentration of the particles in that part as well as the concentration of the particles in other parts of the light guide sheet. In an embodiment of the present invention, for achieving a certain setting of light emanation patterns over the light guide, the concentration of light diffusing particles is adjusted as a function of position in the light guide. Such a function relating concentration of particles to the position in the light guide is henceforth referred to as the concentration profile of particles.

Apart from varying the concentrations, the orientations may also be varied, as has been disclosed in other embodiments of the present invention.

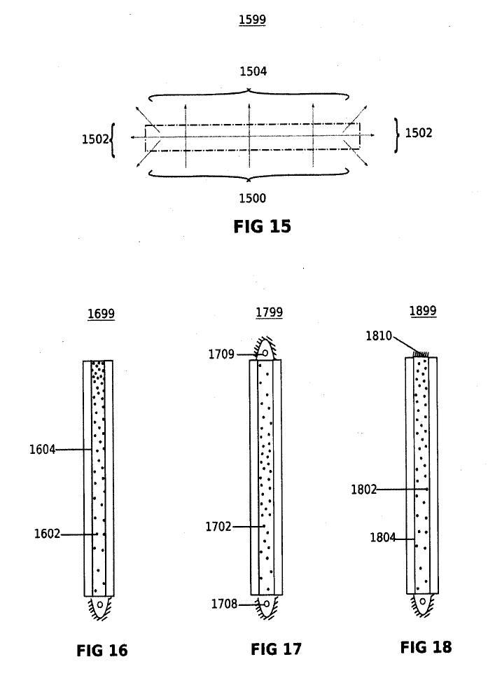

FIG. 15 illustrates a block diagram of a light source in the form of a surface 1599, according to one embodiment. Core element 1599 has the thickness and breadth of the core 1504 but has a very small height. Light 1500 enters element 1599. Some of the light gets dispersed and leaves the light guide as illumination light 1502, and the remaining light 1504 travels on to the next core element. The power of the light 1500 going in is matched by the sum of the powers of the dispersed light 1502 and the light continuing to the next core element 1504. The fraction of light dispersed 1502 with respect to the light 1500 entering the core element 1599 is the photic dispersivity of core element 1599. The photic dispersivity of core element 1599 is in direct proportion to the height of core element 1599. The ratio of the photic dispersivity of core element 1599 to the height of core element 1599 is the photic dispersion density of core element 1599. As the height of core element 1599 decreases, the photic dispersion density approaches a constant. This photic dispersion density of core element 1599 bears a certain relationship to the diffuser concentration at the core element 1599. The relationship is approximated to a certain degree as a direct proportion. The relationship is determined by knowing the diffuser concentration of an element allows evaluation of the photic dispersion density of core element 1599, and vice versa.

As the height of core element 1599 is reduced, power in the emanating light 1502 reduces proportionately. The ratio of power of the emanating light 1502 to the height of core element 1599, which approaches a constant as the height of the element is reduced, is the emanated power density at core element 1599. The emanated power density at core element 1599 is the photic dispersion density times the power of the incoming light (i.e. power of light traveling through the element). The gradient of the power of light traveling through the core element 1599 is the negative of the emanated power density. These two relations give a differential equation. This equation can be represented in the form “dP/dh=−qP=−K” where:

h is the height of a core element from the primary light source edge 118

P is the power of the light being guided through that element;

q is the photic dispersion density of the element; and

K is the emanated power density at that element.

This equation is used to find the emanated power density given the photic dispersion density at each element. This equation is also used to find the photic dispersion density of each element, given the emanated power density. To design a particular light source in the form of a surface with a particular emanated power density, the above differential equation is solved to determine the photic dispersion density at each element of the light source, such as the light source 199. From this, the diffuser concentration at each core element of the core is determined. Such a core is used in a light guide, to give a light source of required emanated energy density over the surface of the light source.

If a uniform concentration of diffuser is used in the core, the emanated power density drops exponentially with height. Uniform emanated power density may be approximated by choosing a diffuser concentration such that the power drop from the edge near the light source (such as edge 118) to the opposite edge 120, is minimized. To reduce the power loss and also improve the uniformity of the emanated power, opposite edge reflects light back into the core. In an alternate embodiment, another light source sources light into the opposite edge.

To achieve uniform illumination, the photic dispersion density and hence the diffuser concentration has to be varied over the length of the core. This can be done using the above methodology. The required photic dispersion density is q=K/(A−hK), where A is the power going into the core 104 and K is the emanated power density at each element, a constant number for uniform illumination. If the total height of the linear light source is H, then H times K should be less than A, i.e. total power emanated should be less than total power going into the light guide, in which case the above solution is feasible. If the complete power going into the light guide is utilized for illumination, then H times K equals A. In an exemplary light source, H times K is kept only slightly less than A, so that only a little power is wasted, as well as photic dispersion density is always finite.

FIG. 16 illustrates a block diagram of an exemplary light source in the form of a surface 1699 having a varied concentration of diffuser particles according to one embodiment. The concentration of the diffuser 1602 is varied from sparse to dense from the light source end of linear light source column 1604 to the opposite edge of column 1604.

FIG. 17 illustrates an exemplary light source in the form of a surface 1799 having two light sources according to one embodiment. By using two light sources 1708, 1709, high variations in concentration of diffuser core 1702 in the core is not necessary. The differential equation provided above is used independently for deriving the emanated power density due to each of the light sources 1708, 1709. The addition of these two power densities provides the total light power density emanated at a particular core element.

Uniform illumination for light source 1799 is achieved by photic dispersion density q=1/sqrt((h−H/2)ˆ2+C/Kˆ2) where sqrt is the square root function, ˆ stands for exponentiation, K is the average emanated power density per light source (numerically equal to half the total emanated power density at each element) and C=A (A−HK).

FIG. 18 illustrates a diagram of an exemplary light source in the form of a surface 1899 having a mirrored core 1804, according to one embodiment. By using a mirrored core 1804, high variations in concentration of diffuser 1802 in the core 1804 is not necessary. Top edge of the core 1810 is mirrored, such that it will reflect light back into the core 1804. The photic dispersion density to achieve uniform illumination in light source 1899 is:
q=1/sqrt((h−H)ˆ2+D/Kˆ2)
where D=4A(A−HK).

For any system described above (such as the light sources in the form of surfaces 1899, 1899 and 1899), the same pattern of emanation is sustained even if the light source power changes. For example, if the primary light source of light source 1899 provides half the rated power, each element of the core will emanate half its rated power. Specifically, a light guide core designed to act as a uniform light source as a uniform light source at all power ratings by changing the power of its light source or sources. If there are two light sources, their powers are changed in tandem to achieve this effect.

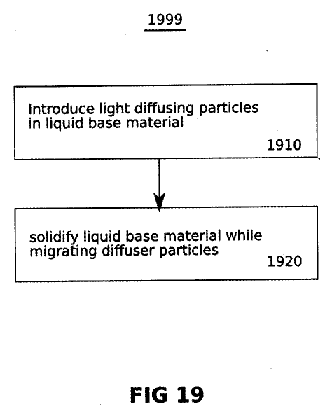

FIG. 19 illustrates a flow diagram of an exemplary process 1999 for creating a concentration profile of particles in a light guide, according to one embodiment. Light diffusing particles are introduced into a liquid base material at a homogeneous or varying concentration (1910). The liquid base material is solidified in a controlled way (1920). Solidification is achieved by cooling the liquid, or by polymerization, or by other physical or chemical means. It is possible that the diffuser material undergoes physical or chemical change during this process. The diffuser particles undergo migration due to physical diffusion and in alternate embodiments, due to buoyant force, convection, non uniform diffusion rates and other forces. The solidifying process uses a controlled temperature or polymerization schedule, or other process such that the rate of physical diffusion of the diffuser in the base material is controlled as a function of time.

To design the initial concentration profile, i.e. the concentration profile of the particles as they are introduced in step 1910, the physical diffusion process is approximated as a linear, location invariant system, namely a convolution operation. The final concentration profile is thus a convolution operation acting on the initial concentration profile. The initial concentration profile may be derived from the final concentration profile (such as profiles disclosed in conjunction with FIGS. 15, 16, 17 and 18) by deconvolution. According to an embodiment, the impulse response of the convolution operation, necessary to perform the deconvolution, is identified experimentally, or using the knowledge of the temperature schedule, or other controlled solidification process used. Because of non location-invariance at the edges, a linear but not location invariant model may be used in another embodiment. The initial concentration profile is then calculated using linear system solution methods, including matrix inversion or the least squares method.

In an embodiment, an orienting force field or a combination of orienting fields are applied during the solidification process 1920 to create an orientation distribution profile at the same time that a concentration profile is being created. In an alternate embodiment, an object is created with particles arranged in a concentration profile, but not oriented in any specific direction. Orientation of the particles is then carried out.

A display with selectable viewing angle and methods pertaining thereto are disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

We claim:

1. An apparatus, comprising
a display comprising at least two backlights, wherein
at least one of the backlights is primarily transparent, and
the at least two backlights emit light in different patterns of emanation.

2. The apparatus of claim 1, wherein at least one pattern of emanation comprises light emanating primarily in a narrow solid angle.

3. The apparatus of claim 1, wherein at least one pattern of emanation comprises light emanating primarily in a wide solid angle.

4. The apparatus of claim 1, further comprising a mirror.

5. A method comprising
selecting viewing angle of a display of a device based on status of power source.

6. A method comprising
selecting viewing angle of a display of a device based on angular spread of viewers.

7. A method comprising
selecting viewing angle of a display of a device based on the current state of video output.

8. A method comprising
selecting viewing angle of a display of a device based on hints from applications running on the device.

9. A method comprising
selecting viewing angle of a display of a device based on a manual override.
